(19) United States
(12) Patent Application Publication
(10) Pub. No.: US 2019/0030690 A1
(43) Pub. Date: Jan. 31, 2019

(54) Combination Castlenut and Barrelnut Socket Adapter for Use with Torque Creating Devices

(71) Applicant: David M. Hamby, Montgomery, TX (US)

(72) Inventor: David M. Hamby, Montgomery, TX (US)

(21) Appl. No.: 15/663,744

(22) Filed: Jul. 29, 2017

(51) Int. Cl. B25B 13/48; B25B 23/10; F41A 21/48

(52) U.S. Cl. CPC B25B 13/48; F41A 21/48; B25B 23/108

(57) ABSTRACT

This disclosure describes embodiments of a Combination Castlenut and Barrelnut Socket Adapter that may be used to remove castlenuts and barrel nuts from firearms.

### BRIEF DESCRIPTION OF THE DRAWINGS

FIG. 1 is a semi-exploded view of the barrel and surrounding parts of an M4 style weapon viewed from the right side of the barrel of the weapon.

FIG. 2 is a view of a barrelnut inside of a Delta Ring on an M4 style weapon viewed from the left front of the weapon, looking along the weapon's barrel.

FIG. 3 is an isometric illustration from an end perspective of an embodiment, in one form, of the Barrelnut Adapter Socket of a Combination Castlenut and Barrelnut Socket Adapter.

FIG. 4 is an illustration from an angled perspective of an embodiment, in one form, of the Barrelnut Adapter Socket of a Combination Castlenut and Barrelnut Socket Adapter.

FIG. 5 is an illustration of an embodiment, in one form, of the Barrelnut Adapter Socket being fitted over a barrel of an M4 style weapon so as to be able to mate with a barrelnut.

FIG. 6 is an illustration of an embodiment, in one form, of the Barrelnut Adapter Socket being fitted over a barrelnut and of one form of a torque creating device being fitted over an embodiment, in one form, of a Combination Castlenut and Barrelnut Socket Adapter to apply torque to unscrew the barrelnut.

FIG. 7 is an isometric illustration of a castlenut that is used on an M4 style weapon.

FIG. 8 is a view of a castlenut on an M4 style weapon viewed from the butt of the weapon after the weapon's stock has been removed in order to gain access to the castlenut.

FIG. 9 is an isometric illustration from an end perspective of an embodiment, in one form, of the Castlenut Adapter Socket of the Combination Castlenut and Barrelnut Socket Adapter.

FIG. 10 is an illustration from an angled perspective of an embodiment, in one form, of the Castlenut Adapter Socket of a Combination Castlenut and Barrelnut Socket Adapter.

FIG. 11 is an illustration of an embodiment, in one form, of the Castlenut Adapter Socket being fitted over a positional stock rail so as to be able to mate with a castlenut.

FIG. 12 is an illustration of an embodiment, in one form, of the Castlenut Adapter Socket being fitted over a positional stock rail so as to be able to mate with a castlenut.

FIG. 13 is an illustration from a side perspective of an embodiment, in one form, of the Castlenut Adapter Socket being fitted over a positional stock rail so as to be able to mate with a castlenut and further illustrating an ability of the Combination Castlenut and Barrelnut Socket Adapter to be able to clear the Positional Stock Rail when the Castlenut Adapter Socket is turned.

FIG. 14 is an illustration of an embodiment, in one form, of the Castlenut Adapter Socket being fitted over a castlenut and of one form of a torque creating device being fitted over an embodiment, in one form, of a Combination Castlenut and Barrelnut Socket Adapter.

FIG. 15 is an isometric illustration of a side view of an alternative embodiment, in one form, of the Combination Castlenut and Barrelnut Socket Adapter where the notch portion that is conformably made to be able to clear the Positional Stock Rail on the butt of the weapon is positioned in the forefront of the perspective.

FIG. 16 is an isometric illustration from an end perspective of an alternative embodiment, in one form, of the Barrelnut Adapter Socket of the Combination Castlenut and Barrelnut Socket Adapter.

FIG. 17 is an illustration from an angled perspective of an alternative embodiment, in one form, of the Barrelnut Adapter Socket of a Combination Castlenut and Barrelnut Socket Adapter.

FIG. 18 is an illustration of an alternative embodiment, in one form, of the Barrelnut Adapter Socket being fitted over a barrelnut and of one form of a torque creating device being fitted over an alternative embodiment, in one form, of a Combination Castlenut and Barrelnut Socket Adapter.

FIG. 19 is an isometric illustration from an end perspective of an alternative embodiment, in one form, of the Castlenut Adapter Socket of the Combination Castlenut and Barrelnut Socket Adapter.

FIG. 20 is an illustration from an angled perspective of an alternative embodiment, in one form, of the Castlenut Adapter Socket of the Castlenut Adapter Socket of a Combination Castlenut and Barrelnut Socket Adapter.

FIG. 21 is an illustration of an alternative embodiment, in one form, of the Castlenut Adapter Socket being fitted over a castlenut and of one form of a torque creating device being fitted over an alternative embodiment, in one form, of a Combination Castlenut and Barrelnut Socket Adapter.

### DETAILED DESCRIPTION OF THE EMBODIMENTS

An article of manufacture is disclosed which will be called a Combination Castlenut and Barrelnut Socket Adapter; it is also referred to sometimes as a CN & BN Socket Adapter.

As used in this application, the term “M4 style weapon” includes the M16, AR15, M4 and similar firearms, as well as firearms whose designs are approximately similar to, or which are directly or indirectly derived from, previously and currently produced versions of the M16, AR15 and M4.

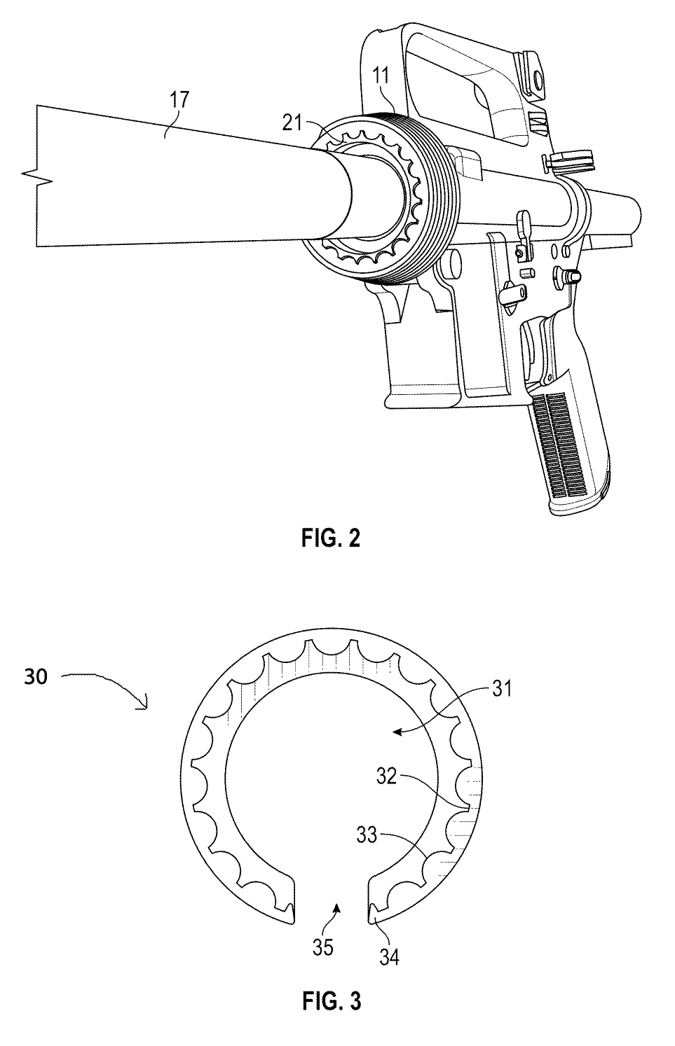

M4 style weapons use a Barrel Nut (shown as 21 in FIG. 2) to firmly affix the barrel to the upper receiver. In order to remove the barrel from the upper receiver, it is first necessary to remove the Barrel Nut.

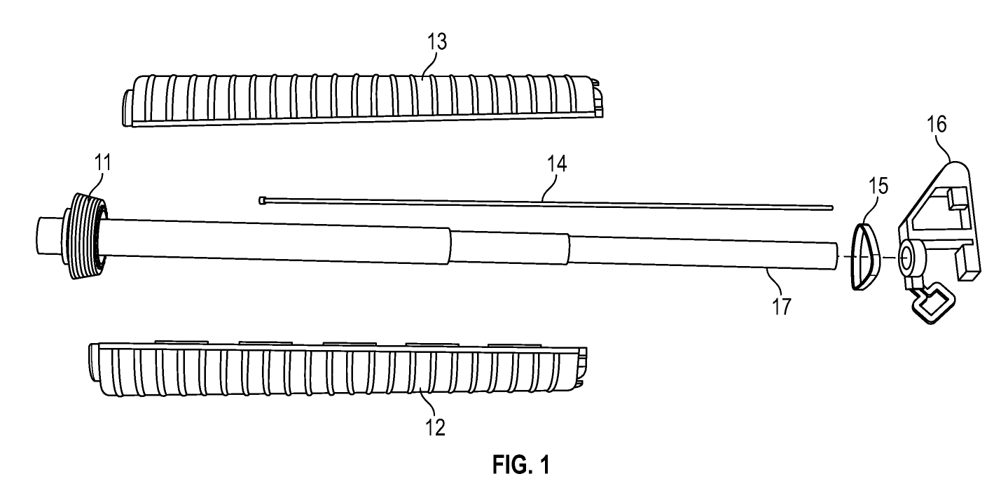

Certain parts of an M4 style weapon are typically disassembled in order to gain access to the Barrel Nut. FIG. 1 illustrates the parts that are typically disassembled in order to gain access to the Barrel Nut. As shown by FIG. 1, there is a Delta Ring, 11, near the base of the Barrel, 17. When this Delta Ring is pushed back against its internal spring loaded tensioner and in the direction of the upper receiver, it is then possible to remove the Bottom Handguard, 12, the Top Handguard, 13, the Gas Tube, 14, the Handguard End Cap, 15 and the Gas Block, 16 in order to leave only an exposed Barrel, 17.

FIG. 2 shows that, once certain parts of the M4 style weapon are disassembled in the manner shown in FIG. 1, the Barrel Nut, 21, which fits inside the Delta Ring, 11, may be accessed; the Barrel, 17, protrudes through the Barrel Nut which secures the barrel to the upper receiver of the M4 style weapon.

FIG. 3 shows an embodiment, in one form, of a Barrelnut Engagement Portion, 30, of the CN & BN Socket Adapter. The Barrelnut Engagement Portion is designed to securely engage the Barrel Nut, 21, so that torque can be applied to the Barrel Nut in order to remove it. The form of the embodiment disclosed in FIG. 3 shows a Barrelnut Adapter Socket, 31, a plurality of Bottom Land, 32, and a plurality of Cylindania Tooth, 33, two Partial Cylindania Tooth, 34 and a Positional Stock Rail Clearing Notch, 35. All of these are configured to conformably and securely grip the corresponding counter surfaces on the exterior of the Barrel Nut.

Although the embodiment disclosed in FIG. 3 shows two Partial Cylindania Tooth, 34, it is possible to satisfactorily construct the Barrelnut Engagement Portion of the CN & BN Socket Adapter to function as intended without them and the inclusion of either or both Partial Cylindania Tooth is optional.

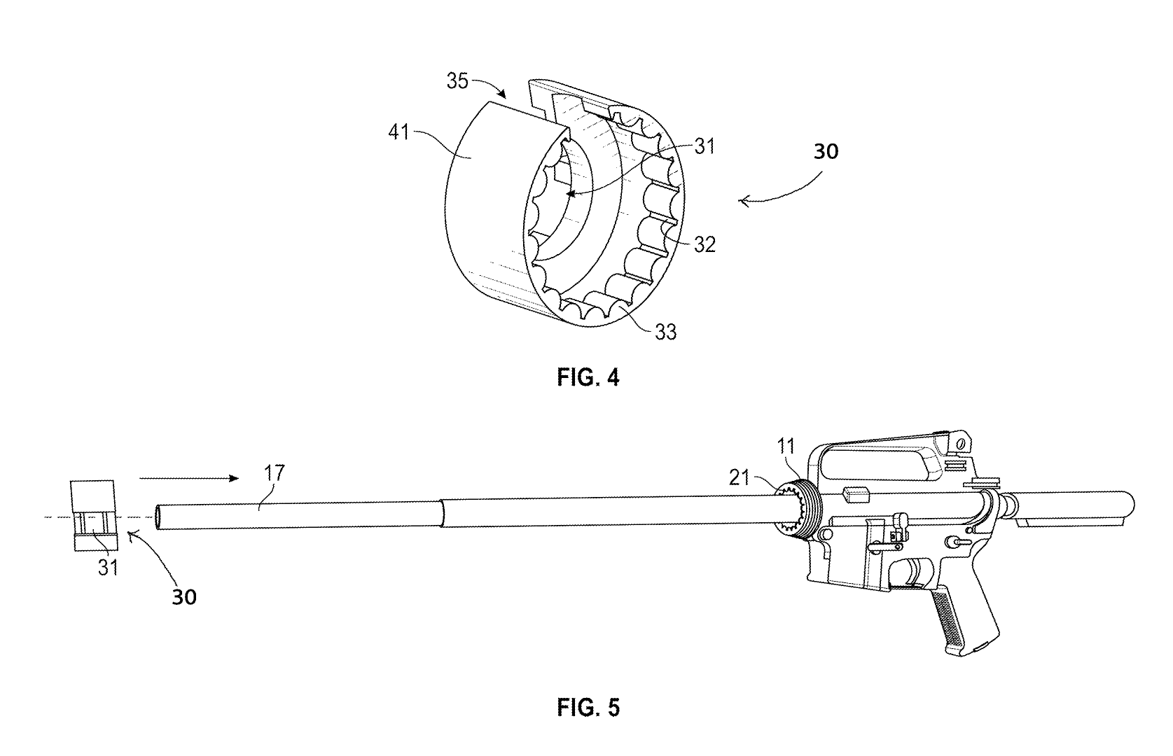

FIG. 4 shows the same embodiment, in one form, of a Barrelnut Engagement Portion, 30, of the CN & BN Socket Adapter depicted in FIG. 3, but from a different perspective.

As shown by FIG. 4, in one embodiment, the CN & BN Socket Adapter, possesses a Cylindrical Gripping Face, 41. Although a Cylindrical Gripping Face is illustrated in FIG. 4, the disclosure made in this application is intended to cover a gripping face of any configuration that can serve as an interface with any tool that can be used to generate torque on the Barrel Nut when gripped by a tool that can be used to generate torque on the exterior face of the CN & BN Socket Adapter.

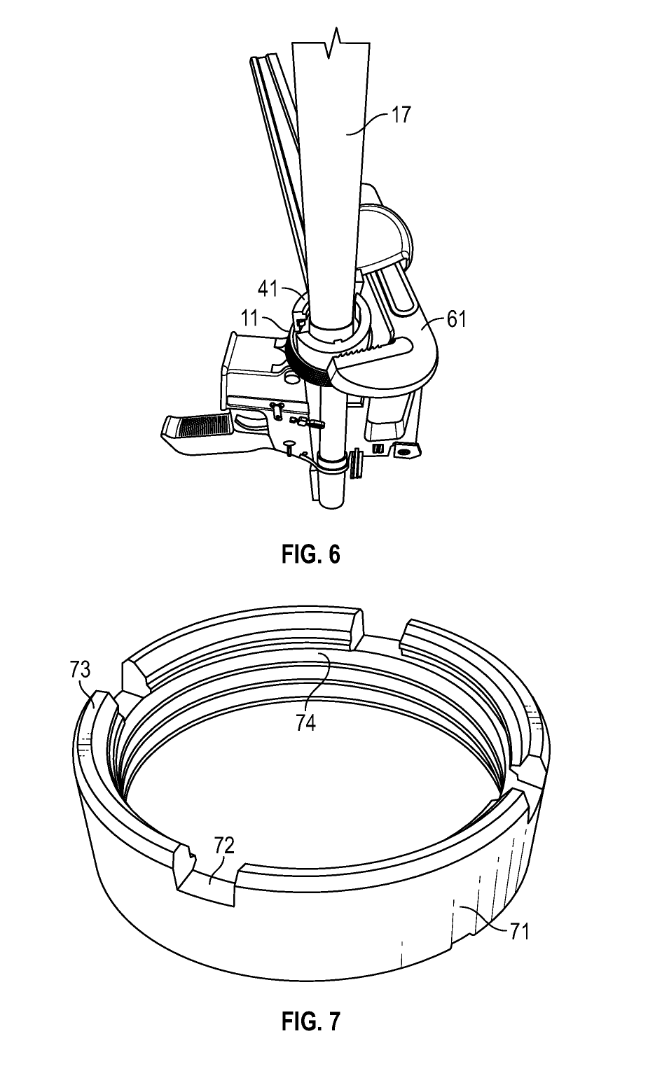

FIG. 5 shows, in one embodiment, how the Barrelnut Engagement Portion of the CN & BN Socket Adapter can slide down the Barrel, 17, to securely engage and conformably fit over the Barrel Nut, 21.

FIG. 6 shows how one embodiment of the CN & BN Socket Adapter can be fitted over the Barrel Nut and also how an embodiment of a Torque Creating Device, 61, can be used to engage with the Cylindrical Gripping Face, 41, in order for a user of the Torque Creating Device to be able to unscrew the Barrel Nut. Note that although a pipe wrench is the embodiment of the Torque Creating Device depicted in FIG. 6, the Torque Creating Device can be any other tool which is capable of engaging the Cylindrical Gripping Face and providing a user leverage with which to generate torque to unscrew the Barrel Nut.

FIG. 7 shows an embodiment, in one form, of a Castlenut, 71. The Castlenut is comprised of a plurality of Crenel, 72, a plurality of Parapet, 73 and contains Threading, 74, on its interior.

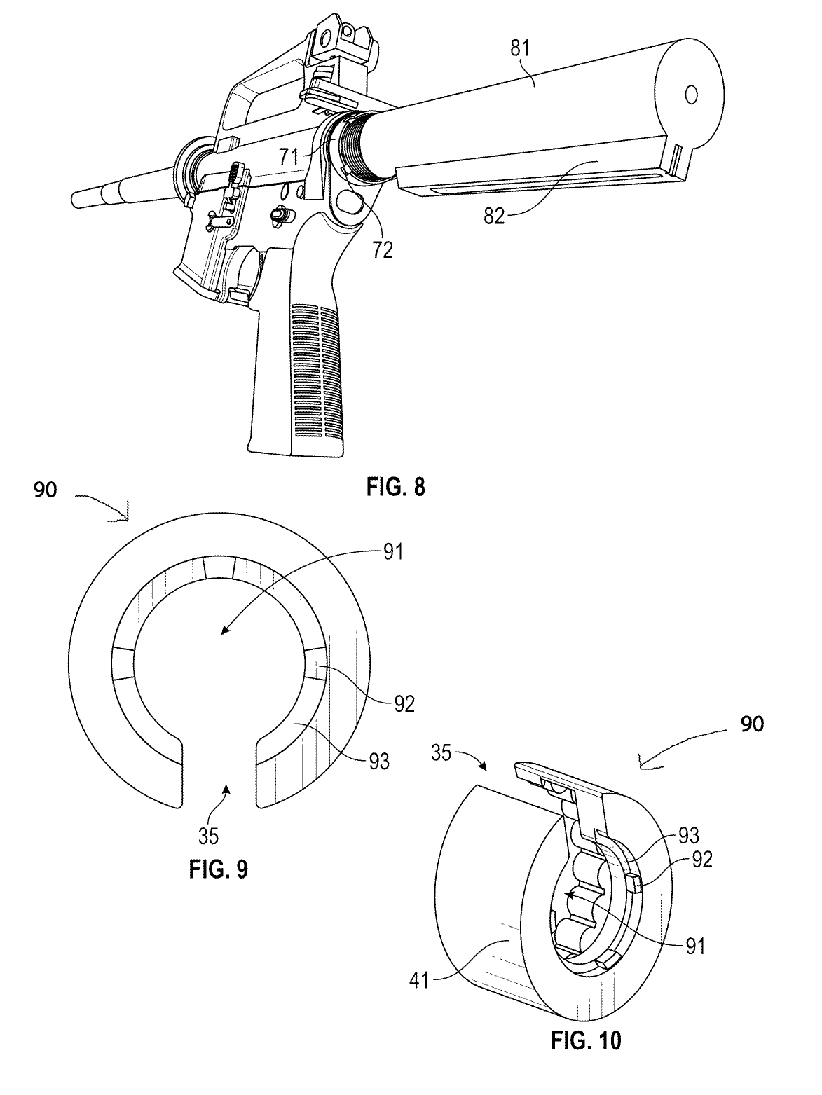

FIG. 8 shows the placement of a Castlenut, 71, as well as the Crenel, 72, on an embodiment of an M4 style weapon. FIG. 8 further shows a Buffer Tube, 81, and a Positional Stock Rail, 82, on an M4 syle weapon.

FIG. 9 shows an embodiment, in one form, of the Castlenut Engagement Portion, 90, of a CN & BN Socket Adapter in which a Castlenut Adapter Socket, 91, is shown adjacent to a Positional Stock Rail Clearing Notch, 35, a plurality of Reverse Crenellated Tooth, 92, and Reverse Parapet Bottom Land, 93.

FIG. 10 shows the same embodiment, in one form, of the CN & BN Socket Adapter depicted in FIG. 9 and additionally illustrates the existence of a Cylindrical Gripping Face, 41, on the exterior of the disclosed embodiment.

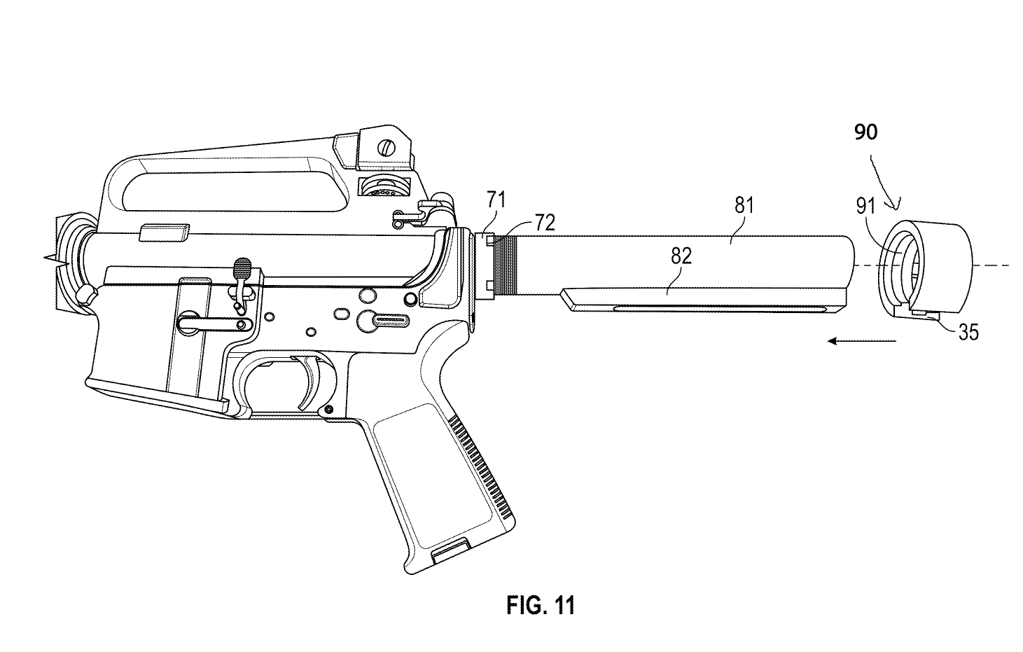

FIG. 11 shows the same embodiment, in one form, of the CN & BN Socket Adapter depicted in FIGS. 9 and 10 being positioned in such a manner that it can slide over the Buffer Tube, 81, with the Positional Stock Rail Clearing Notch, 35, positioned in such a manner that the Positional Stock Rail, 82, will pass through the Positional Stock Rail Clearing Notch, thereby allowing Castlenut Engagement Portion, 90, and its Castlenut Adapter Socket, 91, to engage the Castlenut, 71.

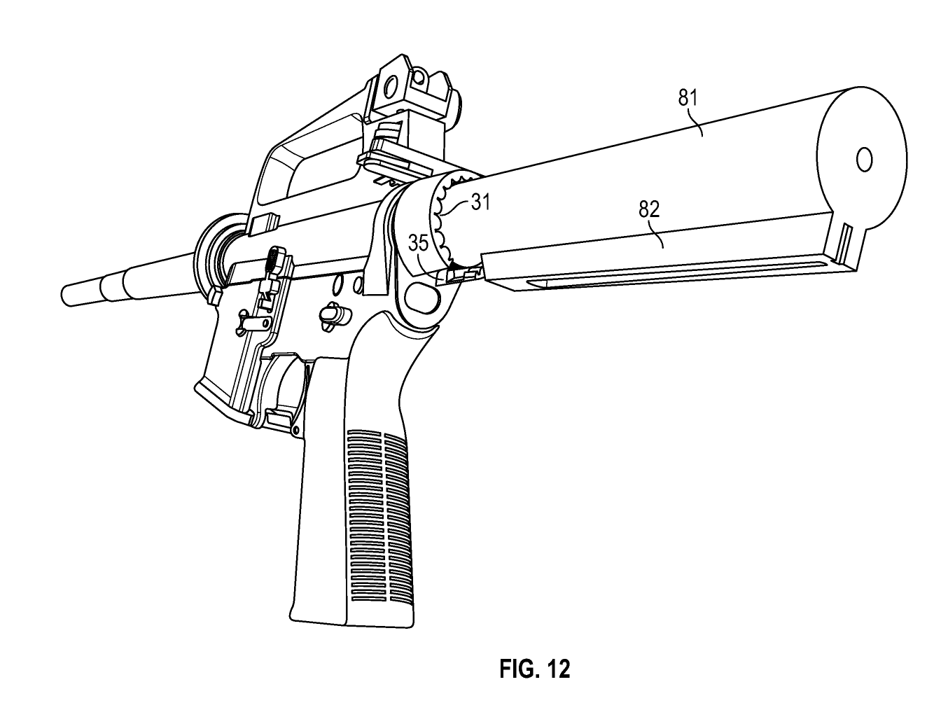

FIG. 12 shows the same embodiment, in one form, of the CN & BN Socket Adapter depicted in FIGS. 9, 10 and 11, fitted over the Buffer Tube, 81, so as to be able to mate with a Castlenut.

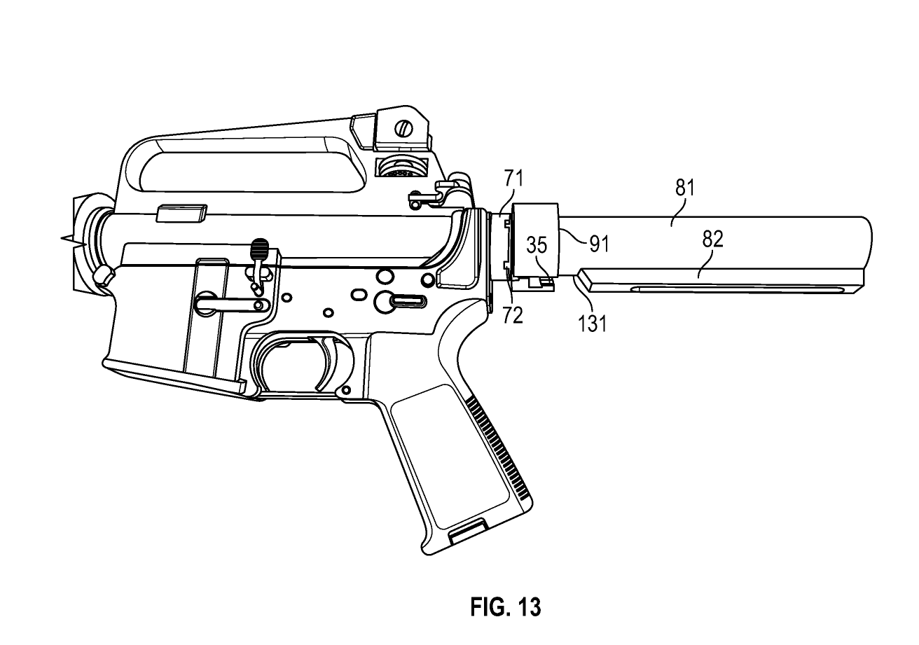

FIG. 13 shows the same embodiment, in one form, of the CN & BN Socket Adapter depicted in FIGS. 9, 10, 11 and 12, and also shows that there is a Clearance Space, 131, between the end of the CN & BN Socket Adapter and the Positional Stock Rail, 82, thus allowing the CN & BN Socket Adapter to be able to clear the Positional Stock Rail when the CN & BN Socket Adapter is turned.

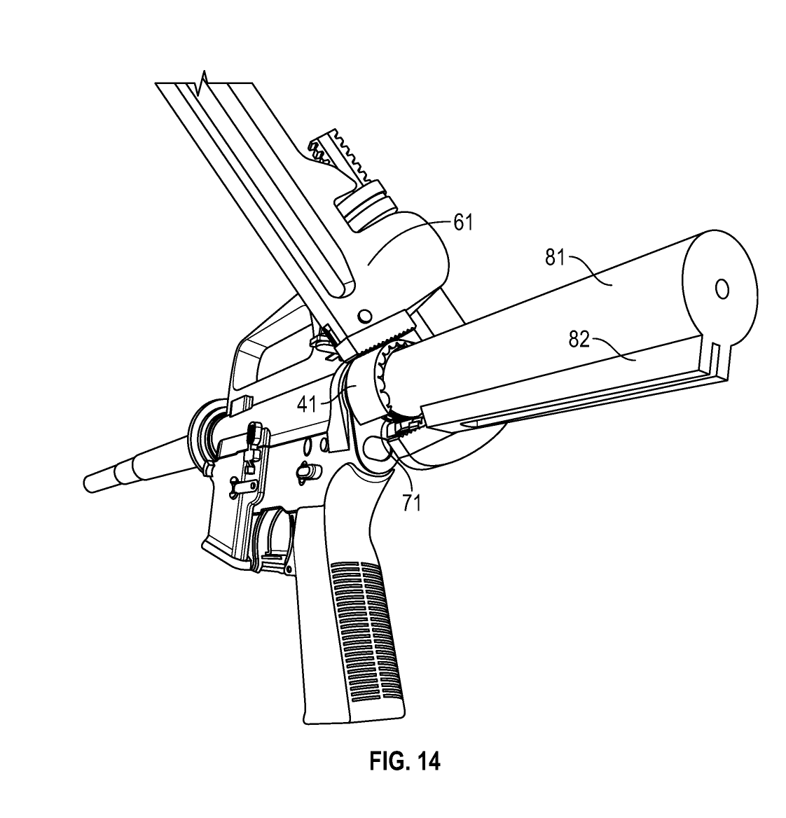

FIG. 14 shows the same embodiment, in one form, of the CN & BN Socket Adapter depicted in FIGS. 9, 10, 11, 12 and 13, being gripped by a Torque Creating Device, 61. Although a pipe wrench is illustrated as being the Torque Creating Device in FIG. 14, any suitable tool may be used that can be used to create sufficient torque to turn the CN & BN Socket Adapter when it is mated with the Castlenut.

When the Castlenut Adapter Socket is fitted over the Castlenut, the Reverse Crenellated Tooth fit conformably into the Crenel. This, combined with the Threading inside the Castlenut, causes the Castlenut to rotate when a sufficient amount of torque is applied to the CN & BN Socket Adapter using a suitable Torque Creating Device.

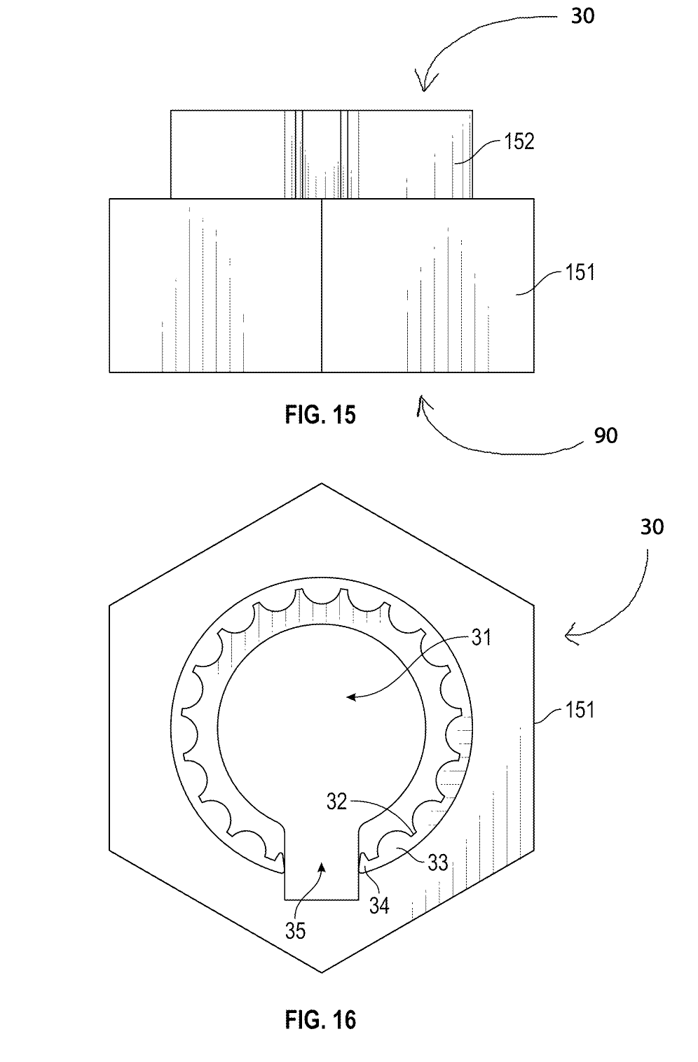

Although the embodiment of the CN & BN Socket Adapter disclosed by FIGS. 3, 4, 5, 6, 9, 10, 11, 12, 13 and 14 possesses a Cylindrical Gripping Face, other embodiments of the CN & BN Socket Adapter can be produced that do not possess a Cylindrical Gripping Face. For instance, it is possible to create embodiments in which the outer face of the CN & BN Socket Adapter is approximately polygonal in shape, as discussed below and as illustrated in FIGS. 15, 16, 17, 18, 19, 20 and 21 or which is only approximately cylindrical.

FIG. 15 shows a side view of an embodiment, in one form, of the CN & BN Socket Adapter in which the Positional Stock Rail Clearing Notch that is conformably made to be able to clear the Positional Stock Rail on the butt of the weapon is positioned in the forefront of the perspective. The depicted embodiment possesses a Polygonal Gripping Face, 151, and a Protrusion to Accommodate Delta Ring, 152. The Barrelnut Engagement Portion, 30, is depicted at the top of FIG. 15 and the Castlenut Engagement Portion, 90, is depicted at the bottom of that same Figure.

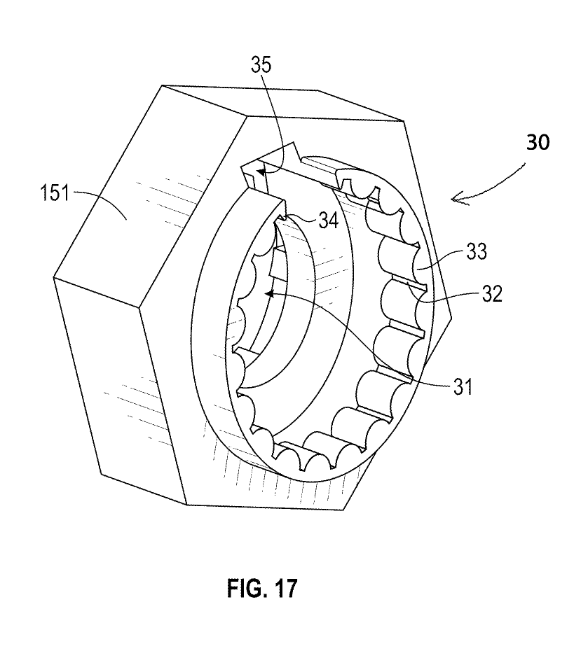

FIG. 16 is a perspective of an embodiment, in one form, of the CN & BN Socket Adapter depicted in FIG. 15, but viewed from the perspective in which the Barrelnut Adapter Socket, 31, of the Barrelnut Engagement Portion, 30, is in the foreground. The plurality of Bottom Land, 32, plurality of Cylindania Tooth, 33, plurality of Partial Cylandania Tooth and the Positional Stock Rail Clearing Notch, 35, are all visible from this perspective and the shape of the Polygonal Gripping Face, 151, is also illustrated.

FIG. 17 is another perspective of the same embodiment, in one form, of the CN & BN Socket Adapter depicted in FIGS. 15 and 16, but shown from an angled perspective in order to better illustrate the three dimensional characteristics of the CN & BN Socket

Adapter. In this perspective, the Barrelnut Adapter Socket, 31, of the Barrelnut Engagement Portion, 30, is shown in the foreground.

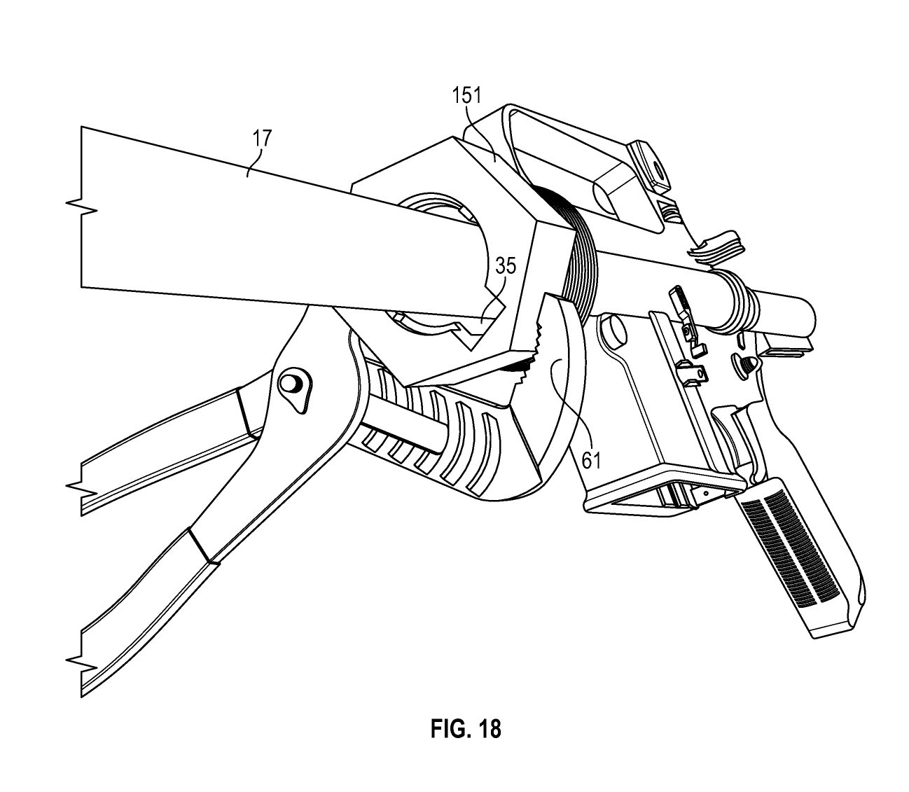

FIG. 18 shows how one embodiment of the CN & BN Socket Adapter, in the same embodiment depicted in FIGS. 15, 16 and 17, can be fitted over the Barrel Nut and also how an embodiment of a Torque Creating Device, 61, can be used to engage with the Polygonal Gripping Face, 151, in order for a user of the Torque Creating Device to be able to unscrew the Barrel Nut. Note that although a pair of adjustable pliers is shown as being used as the embodiment of the Torque Creating Device depicted in FIG. 18, the Torque Creating device can be any other tool which is capable of engaging the Polygonal Gripping Face and providing a user leverage with which to generate torque to unscrew the Barrel Nut.

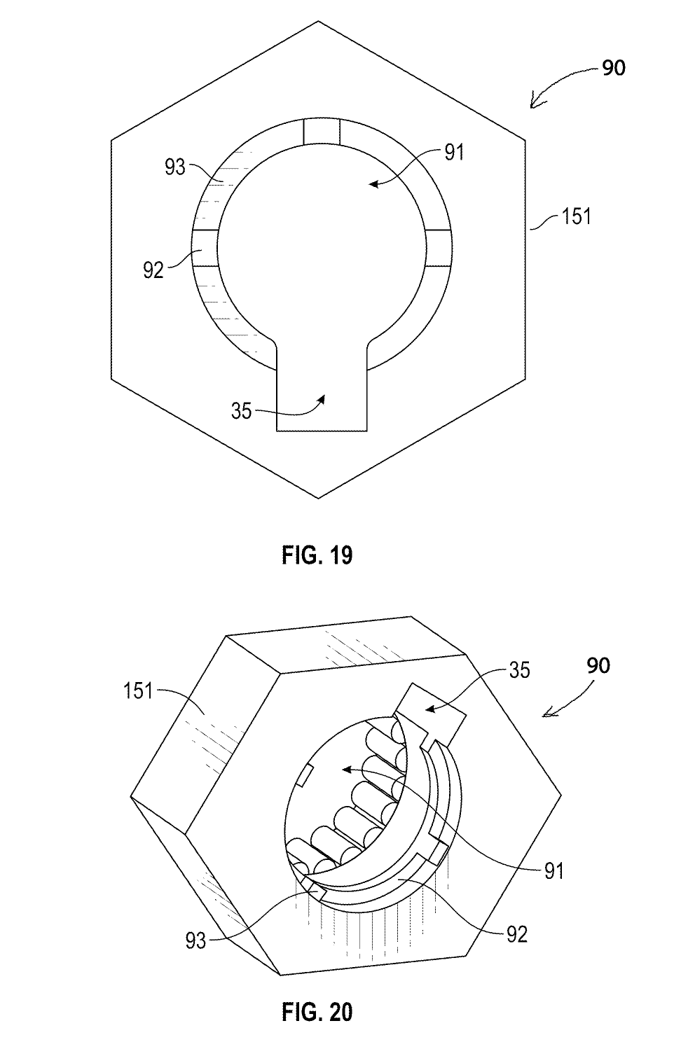

FIG. 19 depicts the Castlenut Engagement Portion, 90, and also shows an embodiment of the CN & BN Socket Adapter, in the same embodiment depicted in FIGS. 15, 16, 17 and 18. FIG. 19 further depicts a Castlenut Adapter Socket, 91, as adjacent to a Positional Stock Rail Clearing Notch, 35, and further depicts a plurality of Reverse Crenellated Tooth, 92, and a plurality of Reverse Parapet Bottom Land, 93.

FIG. 20 depicts the Castlenut Engagement Portion, 90, and also shows an embodiment of the CN & BN Socket Adapter, in the same embodiment depicted in FIGS. 15, 16, 17, 18 and 19 and additionally illustrates the existence of a Polygonal Gripping Face, 151, on the exterior of the disclosed embodiment.

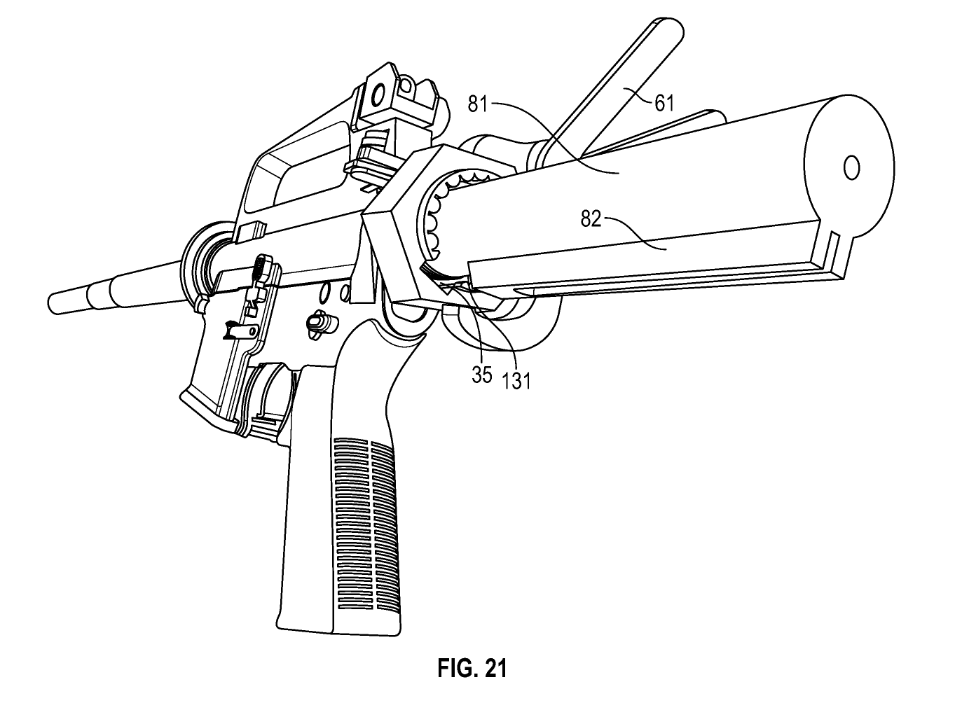

FIG. 21 shows the same embodiment, in one form, of the CN & BN Socket Adapter depicted in FIGS. 15, 16, 17, 18, 19 and 20, being gripped by a Torque Creating Device, 61. Although a pair of adjustable pliers is illustrated as being the Torque Creating Device in FIG. 14, any suitable tool may be used that can be used to create sufficient torque to turn the CN & BN Socket Adapter when it is mated with the Castlenut.

1. An apparatus for ambidextrously holding open the bolt of a Kalashnikov style firearm, for ambidextrously selecting whether the Kalashnikov style firearm will fire multiple rounds or a single round each time the user pulls and holds down the trigger on the firearm and for ambidextrously selecting whether the Kalashnikov style firearm will fire when the user pulls the trigger on the firearm when the Kalashnikov style firearm is equipped with a left receiver, a right receiver, a charging handle, an auto sear mounting pin, a primary keyhole, a secondary mounting hole, a bolt carrier assembly and a recoil spring assembly, a disconnector, a hammer and a trigger assembly, said apparatus comprising:
a primary selector piece, comprising:
a single rigid member, comprising:
an external part which extends laterally along the right receiver, comprising:
a means for creating friction between the external part and the right receiver;
a means for conformably clearing the auto sear mounting pin by allowing the external part to pass over the auto sear mounting pin;
a rigid hold open member extending from the external part so as to conformably engage the front of the firearm's charging handle in such a manner that prevents the bolt of the firearm from closing for so long as the hold open member is engaging the front of the firearm's charging handle;
a right thumb piece operatively configured to provide leverage to a user rotating the primary selector piece;
an internal part which is approximately orthogonal to the external part and which extends through the primary keyhole in the right receiver and through the secondary mounting hole in the left receiver, comprising:
a means for pivoting on keyhole passthrough;
a means for blocking mechanism which is capable of blocking the disconnector and the trigger assembly;
a means for permitting reciprocation of bolt carrier assembly;
a means for pivoting on secondary mounting hole that possesses an insertion space conformably made to accommodate a means for fastening the primary selector piece to the left thumb piece;
a left thumb piece operatively configured to provide leverage to a user rotating the primary selector piece; and
a means for fastening the primary selector piece to the left thumb piece.

2. An apparatus for ambidextrously selecting whether a Kalashnikov style firearm having a left receiver, a right receiver, an auto sear mounting pin, a primary keyhole, a secondary mounting hole, a hammer and a trigger assembly will fire when the user pulls the trigger on the firearm, said apparatus comprising:
a primary selector piece, comprising:
a single rigid member, comprising:
an external part which extends laterally along the right receiver, comprising:
a means for creating friction between the external part and the right receiver;
a means for conformably clearing the auto sear mounting pin by allowing the external part to pass over the auto sear mounting pin;
a right thumb piece operatively configured to provide leverage to a user rotating the primary selector piece;
an internal part which is approximately orthogonal to the external part and which extends through the primary keyhole in the right receiver and through the secondary mounting hole in the left receiver, comprising:
a means for pivoting on keyhole passthrough;
a means for blocking mechanism which is capable of blocking the trigger assembly
a means for permitting reciprocation of bolt carrier assembly;
a means for pivoting on secondary mounting hole that possesses an insertion space conformably made to accommodate a means for fastening the primary selector piece to the left thumb piece;
a left thumb piece operatively configured to provide leverage to a user rotating the primary selector piece; and
a means for fastening the primary selector piece to the left thumb piece.

3. An apparatus for ambidextrously selecting whether the Kalashnikov style firearm will fire multiple rounds or a single round each time the user pulls and holds down the trigger on the firearm and for ambidextrously selecting whether the Kalashnikov style firearm will fire when the user pulls the trigger on the firearm when the Kalashnikov style firearm is equipped with a left receiver, a right receiver, a charging handle, an auto sear mounting pin, a primary keyhole, a secondary mounting hole, a bolt carrier assembly and a recoil spring assembly, a disconnector, a hammer and a trigger assembly, said apparatus comprising:
a primary selector piece, comprising:
a single rigid member, comprising:
an external part which extends laterally along the right receiver, comprising:
a means for creating friction between the external part and the right receiver;
a means for conformably clearing the auto sear mounting pin by allowing the external part to pass over the auto sear mounting pin;
a rigid hold open member extending from the external part so as to conformably engage the front of the firearm's charging handle in such a manner that prevents the bolt of the firearm from closing for so long as the hold open member is engaging the front of the firearm's charging handle;
a right thumb piece operatively configured to provide leverage to a user rotating the primary selector piece;
an internal part which is approximately orthogonal to the external part and which extends through the primary keyhole in the right receiver and through the secondary mounting hole in the left receiver, comprising:
a means for pivoting on keyhole passthrough;
a means for blocking mechanism which is capable of blocking the disconnector and the trigger assembly;
a means for permitting reciprocation of bolt carrier assembly;
a means for pivoting on secondary mounting hole that possesses an insertion space conformably made to accommodate a means for fastening the primary selector piece to the left thumb piece;
a left thumb piece operatively configured to provide leverage to a user rotating the primary selector piece; and
a means for fastening the primary selector piece to the left thumb piece.

4. An apparatus for ambidextrously holding open the bolt of a Kalashnikov style firearm, for ambidextrously selecting whether the Kalashnikov style firearm will fire a single round each time the user pulls and holds down the trigger on the firearm and for ambidextrously selecting whether the Kalashnikov style firearm will fire when the user pulls the trigger on the firearm when the Kalashnikov style firearm is equipped with a left receiver, a right receiver, a charging handle, a primary keyhole, a secondary mounting hole, a bolt carrier assembly and a recoil spring assembly, a disconnector, a hammer and a trigger assembly, said apparatus comprising:
a primary selector piece, comprising:
a single rigid member, comprising:
an external part which extends laterally along the right receiver, comprising:
a means for creating friction between the external part and the right receiver;
a rigid hold open member extending from the external part so as to conformably engage the front of the firearm's charging handle in such a manner that prevents the bolt of the firearm from closing for so long as the hold open member is engaging the front of the firearm's charging handle;
a right thumb piece operatively configured to provide leverage to a user rotating the primary selector piece;
an internal part which is approximately orthogonal to the external part and which extends through the primary keyhole in the right receiver and through the secondary mounting hole in the left receiver, comprising:
a means for pivoting on keyhole passthrough;
a means for blocking mechanism which is capable of blocking the disconnector and the trigger assembly;
a means for permitting reciprocation of bolt carrier assembly;
a means for pivoting on secondary mounting hole that possesses an insertion space conformably made to accommodate a means for fastening the primary selector piece to the left thumb piece;
a left thumb piece operatively configured to provide leverage to a user rotating the primary selector piece; and
a means for fastening the primary selector piece to the left thumb piece.

5. An apparatus for ambidextrously selecting whether a Kalashnikov style firearm having a left receiver, a right receiver, a primary keyhole, a secondary mounting hole, a hammer and a trigger assembly will fire when the user pulls the trigger on the firearm, said apparatus comprising:
a primary selector piece, comprising:
a single rigid member, comprising:
an external part which extends laterally along the right receiver, comprising:
a means for creating friction between the external part and the right receiver;
a right thumb piece operatively configured to provide leverage to a user rotating the primary selector piece;
an internal part which is approximately orthogonal to the external part and which extends through the primary keyhole in the right receiver and through the secondary mounting hole in the left receiver, comprising:
a means for pivoting on keyhole passthrough;
a means for blocking mechanism which is capable of blocking the trigger assembly
a means for permitting reciprocation of bolt carrier assembly;
a means for pivoting on secondary mounting hole that possesses an insertion space conformably made to accommodate a means for fastening the primary selector piece to the left thumb piece;
a left thumb piece operatively configured to provide leverage to a user rotating the primary selector piece; and
a means for fastening the primary selector piece to the left thumb piece.

6. An apparatus for ambidextrously selecting whether the Kalashnikov style firearm will fire a single round each time the user pulls and holds down the trigger on the firearm and for ambidextrously selecting whether the Kalashnikov style firearm will fire when the user pulls the trigger on the firearm when the Kalashnikov style firearm is equipped with a left receiver, a right receiver, a charging handle, a primary keyhole, a secondary mounting hole, a bolt carrier assembly and a recoil spring assembly, a disconnector, a hammer and a trigger assembly, said apparatus comprising:
a primary selector piece, comprising:
a single rigid member, comprising:
an external part which extends laterally along the right receiver, comprising:
a means for creating friction between the external part and the right receiver;
a rigid hold open member extending from the external part so as to conformably engage the front of the firearm's charging handle in such a manner that prevents the bolt of the firearm from closing for so long as the hold open member is engaging the front of the firearm's charging handle;
a right thumb piece operatively configured to provide leverage to a user rotating the primary selector piece;
an internal part which is approximately orthogonal to the external part and which extends through the primary keyhole in the right receiver and through the secondary mounting hole in the left receiver, comprising:
a means for pivoting on keyhole passthrough;
a means for blocking mechanism which is capable of blocking the disconnector and the trigger assembly;
a means for permitting reciprocation of bolt carrier assembly;
a means for pivoting on secondary mounting hole that possesses an insertion space conformably made to accommodate a means for fastening the primary selector piece to the left thumb piece;
a left thumb piece operatively configured to provide leverage to a user rotating the primary selector piece; and
a means for fastening the primary selector piece to the left thumb piece.

7. The means for pivoting on keyhole passthrough as recited in claim 1 wherein the radial cross-section of said means for pivoting on keyhole passthrough comprises a shape selected from the group consisting of: a polygon, an ellipse and a circle.

8. The means for pivoting on keyhole passthrough as recited in claim 2 wherein the radial cross-section of said means for pivoting on keyhole passthrough comprises a shape selected from the group consisting of: a polygon, an ellipse and a circle.

9. The means for pivoting on keyhole passthrough as recited in claim 3 wherein the radial cross-section of said means for pivoting on keyhole passthrough comprises a shape selected from the group consisting of: a polygon, an ellipse and a circle.

10. The means for pivoting on keyhole passthrough as recited in claim 4 wherein the radial cross-section of said means for pivoting on keyhole passthrough comprises a shape selected from the group consisting of: a polygon, an ellipse and a circle.

11. The means for pivoting on keyhole passthrough as recited in claim 5 wherein the radial cross-section of said means for pivoting on keyhole passthrough comprises a shape selected from the group consisting of: a polygon, an ellipse and a circle.

12. The means for pivoting on keyhole passthrough as recited in claim 6 wherein the radial cross-section of said means for pivoting on keyhole passthrough comprises a shape selected from the group consisting of: a polygon, an ellipse and a circle.

13. The means for pivoting on secondary mounting hole as recited in claim 1 wherein the radial cross-section of said means for pivoting on secondary mounting hole comprises a shape selected from the group consisting of: a polygon, an ellipse and a circle.

14. The means for pivoting on secondary mounting hole as recited in claim 2 wherein the radial cross-section of said means for pivoting on secondary mounting hole comprises a shape selected from the group consisting of: a polygon, an ellipse and a circle.

15. The means for pivoting on secondary mounting hole as recited in claim 3 wherein the radial cross-section of said means for pivoting on secondary mounting hole comprises a shape selected from the group consisting of: a polygon, an ellipse and a circle.

16. The means for pivoting on secondary mounting hole as recited in claim 4 wherein the radial cross-section of said means for pivoting on secondary mounting hole comprises a shape selected from the group consisting of: a polygon, an ellipse and a circle.

17. The means for pivoting on secondary mounting hole as recited in claim 5 wherein the radial cross-section of said means for pivoting on secondary mounting hole comprises a shape selected from the group consisting of: a polygon, an ellipse and a circle.

18. The means for pivoting on secondary mounting hole as recited in claim 6 wherein the radial cross-section of said means for pivoting on secondary mounting hole comprises a shape selected from the group consisting of: a polygon, an ellipse and a circle.

19. The means for fastening the primary selector piece to the left thumb piece as recited in claim 1 wherein said means for fastening the primary selector piece to the left thumb piece comprises a fastener selected from the group consisting of a socket set screw, a roll pin, a nail, a screw, a weld, an epoxy, an adhesive, a magnet, a friction fit and a hitch pin.

20. The means for fastening the primary selector piece to the left thumb piece as recited in claim 2 wherein said means for fastening the primary selector piece to the left thumb piece comprises a fastener selected from the group consisting of a socket set screw, a roll pin, a nail, a screw, a weld, an epoxy, an adhesive, a magnet, a friction fit and a hitch pin.

21. The means for fastening the primary selector piece to the left thumb piece as recited in claim 3 wherein said means for fastening the primary selector piece to the left thumb piece comprises a fastener selected from the group consisting of a socket set screw, a roll pin, a nail, a screw, a weld, an epoxy, an adhesive, a magnet, a friction fit and a hitch pin.

22. The means for fastening the primary selector piece to the left thumb piece as recited in claim 4 wherein said means for fastening the primary selector piece to the left thumb piece comprises a fastener selected from the group consisting of a socket set screw, a roll pin, a nail, a screw, a weld, an epoxy, an adhesive, a magnet, a friction fit and a hitch pin.

23. The means for fastening the primary selector piece to the left thumb piece as recited in claim 5 wherein said means for fastening the primary selector piece to the left thumb piece comprises a fastener selected from the group consisting of a socket set screw, a roll pin, a nail, a screw, a weld, an epoxy, an adhesive, a magnet, a friction fit and a hitch pin.

24. The means for fastening the primary selector piece to the left thumb piece as recited in claim 6 wherein said means for fastening the primary selector piece to the left thumb piece comprises a fastener selected from the group consisting of a socket set screw, a roll pin, a nail, a screw, a weld, an epoxy, an adhesive, a magnet, a friction fit and a hitch pin.
